(19) United States
(12) Patent Application Publication
(10) Pub. No.: US 2006/0266194 A1
(43) Pub. Date: Nov. 30, 2006

(54) Automatic slat-forming machine

(76) Inventor: Tai-Long Huang, Changhua (TW)

Correspondence Address: FROMMER LAWRENCE & HAUG, 745 FIFTH AVENUE- 10TH FL., NEW YORK, NY, 10151, US

(21) Appl. No.: 11/130,456

(22) Filed: May 16, 2005

(51) Int. Cl. B26F 1/14

(52) U.S. Cl. 83/687

(57) ABSTRACT

An automatic slat-forming machine includes a collecting unit, a plurality of cutting units, a plurality of punching units and a control unit. When the control unit is operated, a plate is moved from the collecting unit into the cutting units and the punching units, and is cut and punched to form a window blind slat under automatic control of the control unit.

### BACKGROUND OF THE INVENTION

1. Field of the Invention

This invention relates to a slat-forming machine, and more particularly to an automatic slat-forming machine that can automatically cut and punch a plate to form a window blind slat.

2. Description of the Related Art

Referring to FIG. 1, a conventional slat-forming machine includes a machine bed 11, a control unit 12, a plurality of cutting units 13 and punching units 14 arranged along a first direction (I), a driving unit 15 disposed on the machine bed 11 and connected to the cutting units 13 and the punching units 14, and a collecting unit 16.

The control unit 12 is electrically connected with the driving unit 15, and includes a power control pushbutton 121, a manual control pushbutton 122, and a control circuit (not shown).

With further reference to FIG. 2, which is a partly sectional side view of FIG. 1, the collecting unit 16 is disposed below and in proximity to the cutting units 13 and the punching units 14. The collecting unit 16 includes a semi-product collecting box 161 and a product-collecting box 162. The product-collecting box 162 is disposed between the semi-product box 161 the and an assembly of the cutting units 13 and the punching units 14.

Each of the punching units 14 includes a base 141, a cutter seat 142 disposed above the base 141, an anvil 144 disposed between the base 141 and the cutter seat 142 and having an opening 143, a cutter 145 movable relative to the cutter seat 142 and connected to a driving rod 151 of the driving unit 15, and a resilient member 146 sleeved on the cutter 145 and disposed between the cutter seat 142 and the anvil 144. The cutter 145 of each of the punching units 14 is movable to press against a plate 200 so as to form a slot 201 (see FIG. 4) in the plate 200.

Each of the cutting units 13 also includes a base 131, a cutter seat 132, an opening 133, an anvil 134, a cutter 135 and a resilient member 136. The cutting units 13 are similar in construction to the punching units 14. However, the cutter 135 of each of the cutting units 13 is movable to press against the plate 200 so as to form a curved end edge 202 (see FIG. 4).

Each of the anvils 134, 144 of the cutting units 13 and the punching units 14 has a lower anvil wall 1341, 1441 that is formed with an inclined end surface 1342, 1442. Each of the bases 131, 141 of the cutting units 13 and the punching units 14 is also formed with an inclined end surface 1311, 1411 that is aligned with the corresponding inclined end surface 1342, 1442 of the anvils 134, 144. This guides the plate 200 to move from the openings 133, 143 of the cutting units 13 and the punching units 14 into the collecting unit 16.

With additional reference to FIG. 3, the driving unit 15 further includes a fluid pressure cylinder 152. The fluid pressure cylinder 152 has a movable piston rod 1521 that is formed with a fixed rack 1522. A pinion 153 is sleeved fixedly on the driving rod 151, and engages the rack 1522. As such, movement of the piston rod 1521 results in rotation of the driving rod 151. When the driving rod 151 rotates, cams 154 on the driving rod 151 move the cutters 135, 145 of the cutting units 13 and the punching units 14. Therefore, the slots 201 and the curved end edges 202 of the plate 200 can be formed simultaneously.

In operation, after the power control pushbutton 121 is pressed, one of the plates 200 is moved manually from the semi-product collecting box 161 into the openings 133, 143 in the anvils 134, 144 of the cutting units 13 and the punching units 14. Subsequently, the manual control pushbutton 122 is pressed to result in downward movement of the piston rod 1521 of the fluid pressure cylinder 152 to a position shown by the phantom lines in FIG. 3. Hence, the rack 1522 rotates the pinion 153 and, therefore, the driving rod 151. As a result, the cams 154 rotate to move the cutters 135, 145 so as to perform cutting and punching operations on the plate 200, thereby forming a window blind slat having three slots 201 and two curved end edges 202.

The window blind slat is pushed manually to slide from the cutting units 13 and the punching units 14 into the product-collecting box 162. A disadvantage of the aforesaid conventional slat-forming machine is that movement of the plate 200 from the collecting unit 16 into the cutting units 13 and the punching units 14, movement of the window blind slat from the cutting units 13 and the punching units 14 into the collecting unit 16, and actuation of the manual control pushbutton 122 are performed manually. Such manual operations adversely affect manufacturing productivity and costs.

### SUMMARY OF THE INVENTION

The object of this invention is to provide an automatic slat-forming machine that can be operated so that a plate is moved from a collecting unit into cutting units and punching units, and is cut and punched to form a window blind slat under automatic control.

According to this invention, an automatic slat-forming machine includes a control unit, a plurality of cutting units disposed on the machine bed and arranged along a first direction, and a plurality of punching units disposed on the machine bed and arranged along the first direction. A driving unit is disposed on the machine bed, and is connected to the control unit, the cutting units and the punching units.

The automatic slat-forming machine further includes a pair of first and second driving rod units. Each of the first and second driving rod units includes:
a first fluid pressure cylinder extending along a second direction perpendicular to the first direction and including a first cylinder body disposed fixedly on the machine bed, and a first piston rod movable relative to the first cylinder body;
a connecting frame disposed fixedly on the first piston rod;
a second fluid pressure cylinder extending along a third direction perpendicular to the first and second directions and including a second cylinder body disposed fixedly on the connecting frame, and a second piston rod movable relative to the second cylinder body; and
a suction nozzle attached to an end of the second piston rod.

The control unit is operable so that, under automatic control of the control unit, the slat-forming machine performs the following operations:
moving the second piston rods to predetermined positions along the third direction;
sucking a plate in the collecting unit onto the suction nozzles;
moving the first and second piston rods so as to feed the plate into the cutting units and the punching units;
releasing the plate from the suction nozzles; and
driving the cutting units and the punching units by use of the driving unit to perform cutting and punching operations on the plate so as to form a window blind slat.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic view of a conventional slat-forming machine;

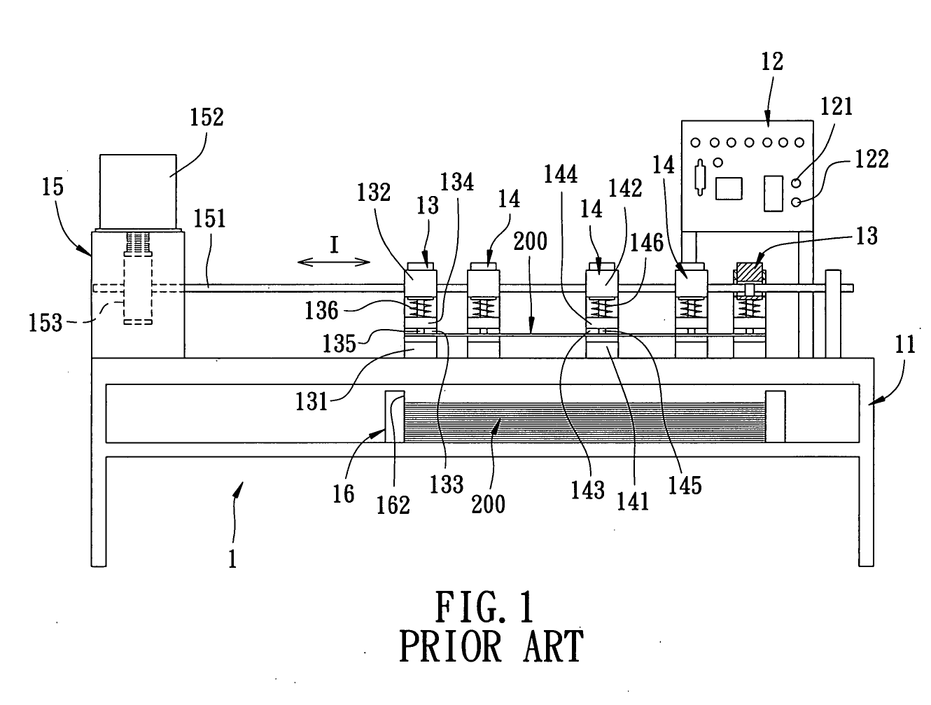

FIG. 2 is a partly sectional side view of the conventional slat-forming machine;

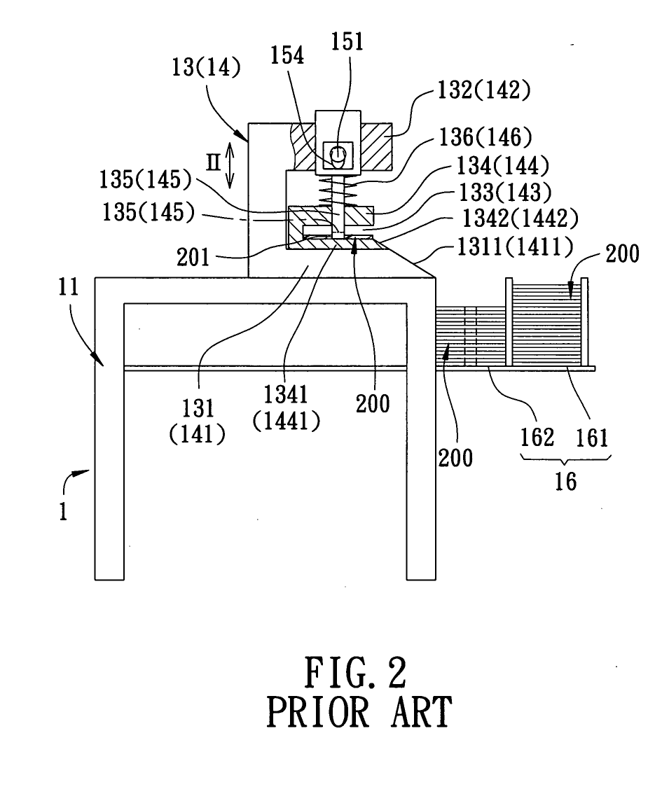

FIG. 3 is a schematic side view of a driving unit of the conventional slat-forming machine;

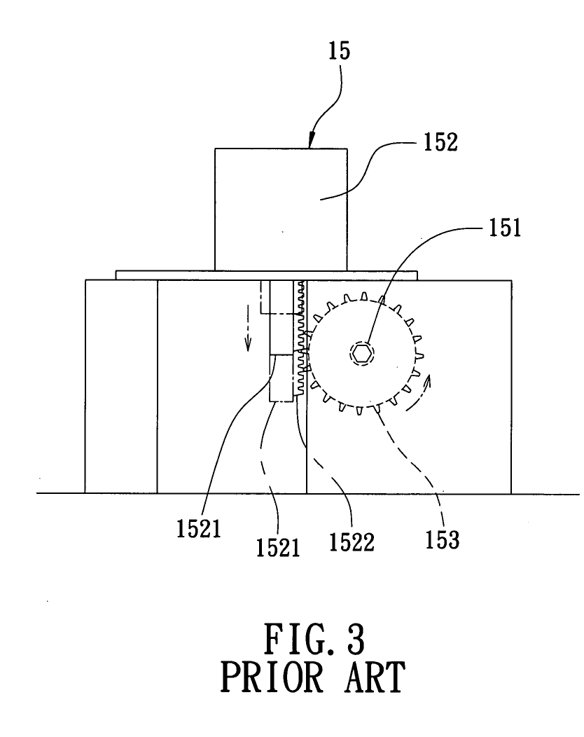

FIG. 4 is a top view of a window blind slat formed from a plate by use of the conventional slat-forming machine;

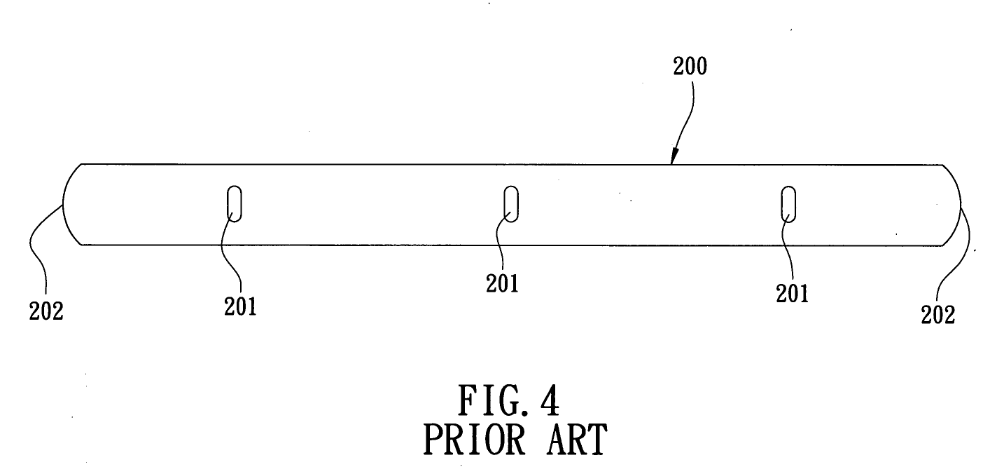

FIG. 5 is a schematic view of the preferred embodiment of an automatic slat-forming machine according to this invention, illustrating how a plurality of cutting units and a plurality of punching units are arranged along a first direction;

FIG. 6 is a schematic side view of a driving unit of the preferred embodiment;

FIG. 7 is a schematic side view of the driving unit of the preferred embodiment, illustrating operation of the driving unit;

FIG. 8 is a schematic side view of the preferred embodiment, illustrating how a first piston rod is moved along a second direction and how a plate is secured by a suction nozzle;

FIG. 9 is a schematic side view of the preferred embodiment, illustrating how the plate is moved upwardly with the suction nozzle along a third direction;

FIG. 10 is a schematic side view of the preferred embodiment, illustrating how the plate is moved into the cutting units and the punching units;

FIG. 11 is a schematic side view of the preferred embodiment, illustrating how a window blind slat is pushed from the cutting units and the punching units into a collecting unit;

FIG. 12 is a fragmentary, partly sectional view of the preferred embodiment, illustrating how cutters are connected to a driving rod;

FIG. 13 is a fragmentary, partly sectional view of the preferred embodiment, illustrating how the cutters are moved downwardly by cams on the driving rod to perform cutting and punching operations on the plate; and

FIG. 14 is a fragmentary, partly sectional view of the preferred embodiment, illustrating how the window blind slat is pushed to slide into the collecting unit along a plurality of inclined surfaces.

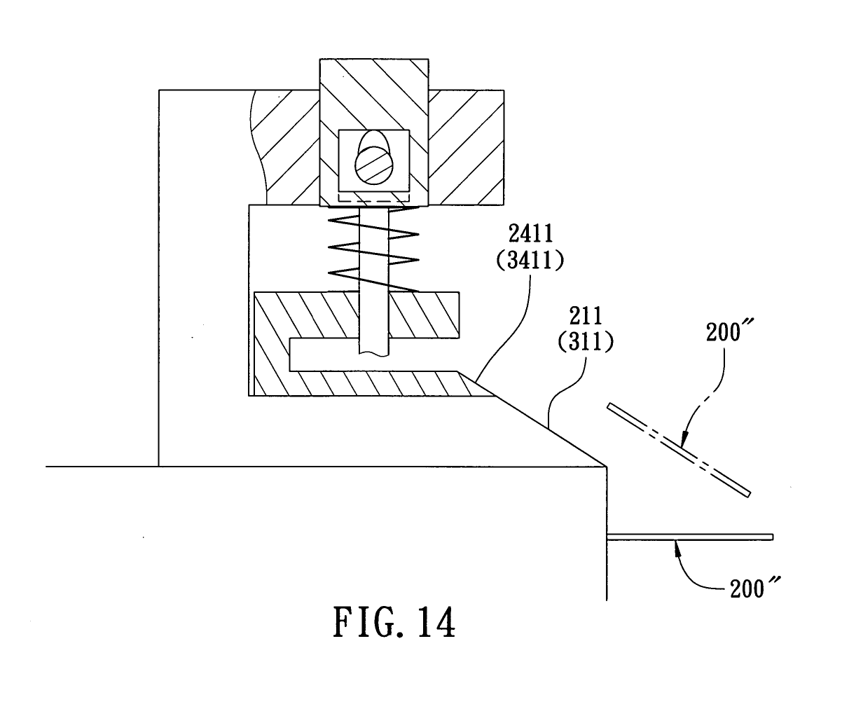

### DETAILED DESCRIPTION OF THE PREFERRED EMBODIMENT

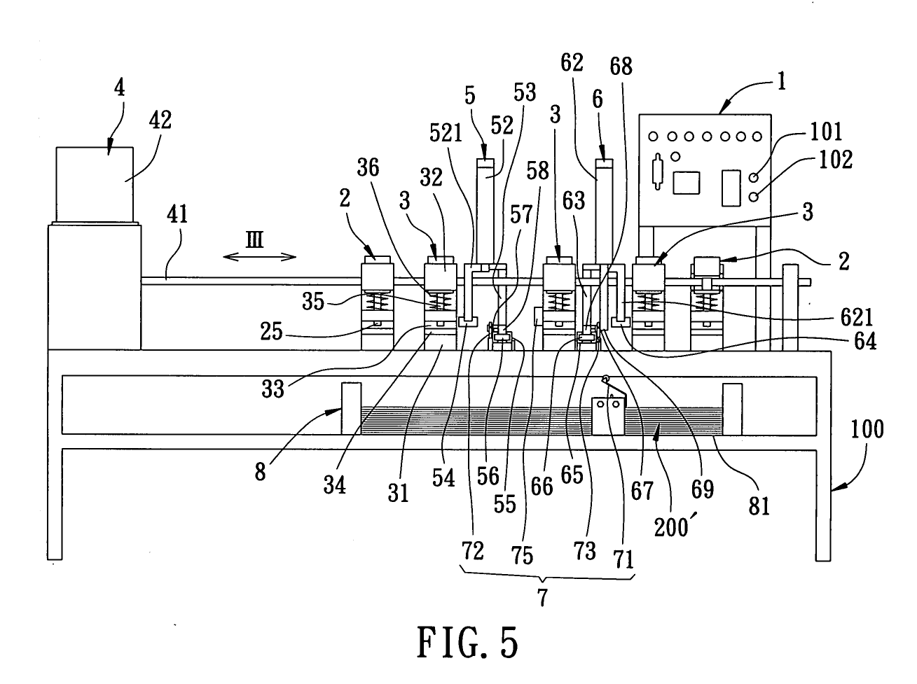

Referring to FIG. 5, the preferred embodiment of an automatic slat-forming machine according to this invention includes a machine bed 100, a control unit 1, a plurality of cutting units 2, a plurality of punching units 3, a driving unit 4, a pair of first and second driving rod units 5, 6, a switch unit 7 and a collecting unit 8.

The control unit 1 includes a power control pushbutton 101, an automatic control pushbutton 102 and a control circuit (not shown).

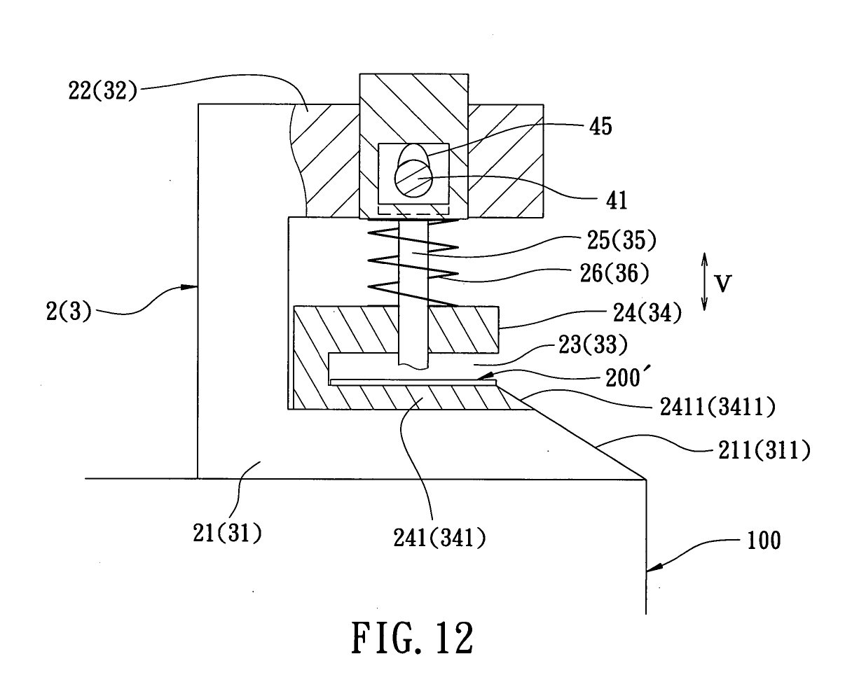

Referring to FIGS. 5 and 12, the cutting units 2 and the punching units 3 are disposed on the machine bed 100, and are arranged along a first direction (III). Each of the cutting units 2 includes a base 21, a cutter seat 22, an anvil 24 having an opening 23, a cutter 25, and a resilient member 26. Each of the cutter seats 22 is disposed above the corresponding base 21. Each of the anvils 24 is disposed between the corresponding base 21 and the corresponding cutter seat 22, and further has a lower anvil wall 241. Each of the lower anvil walls 241 defines a lower end of the corresponding opening 23. Each of the cutters 25 is movable vertically relative to the corresponding cutter seat 22. Each of the punching units 3 is similar in construction to the cutting units 2, and also includes a base 31, a cutter seat 32, an anvil 34 having an opening 33 and a lower anvil wall 341, a cutter 35, and a resilient member 36. The cutting units 2 and the punching units 3 differ only in the structures of the cutters 25, 35.

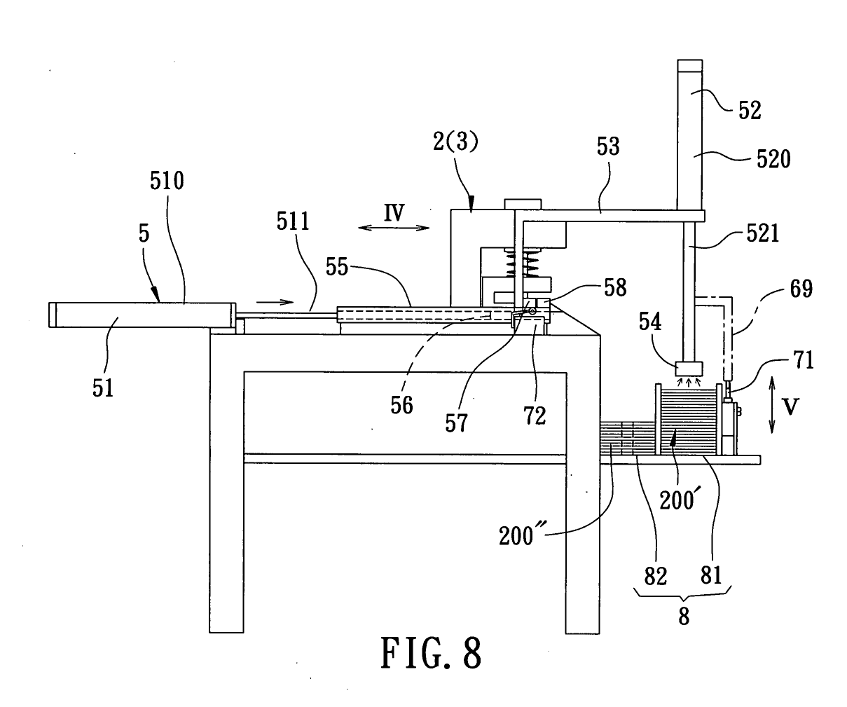

Referring to FIGS. 5 and 8, the first driving rod unit 5 includes a first fluid pressure cylinder 51, a second fluid pressure cylinder 52, a connecting frame 53, a suction nozzle 54, a first slide seat 55, a first sliding block 56, a first contact block 57 and a first push block 58. The first fluid pressure cylinder 51 is disposed on the machine bed 100, and extends along a second direction (IV) perpendicular to the first direction (III). The first fluid pressure cylinder 51 includes a first cylinder body 510 disposed fixedly on the machine bed 100, and a first piston rod 511 movable relative to the first cylinder body 510. The connecting frame 53 is disposed fixedly on the first sliding block 56. The second fluid pressure cylinder 52 extends along a third direction (V) perpendicular to the first and second directions (III, IV), and includes a second cylinder body 520 and a second piston rod 521. The second cylinder body 520 is disposed fixedly on the connecting frame 53. The second piston rod 521 is movable relative to the second cylinder body 520. The suction nozzle 54 is attached to a lower end of the second piston rod 521. The first slide seat 55 is disposed fixedly on the machine bed 100. The first sliding block 56 is connected fixedly to the first piston rod 511, and is disposed movably within the first slide seat 55 along the second direction (IV) so as to guide the first piston rod 511 to move along the second direction (IV). The first contact block 57 is connected fixedly to the first sliding block 56. The first push block 58 is connected fixedly to the first sliding block 56.

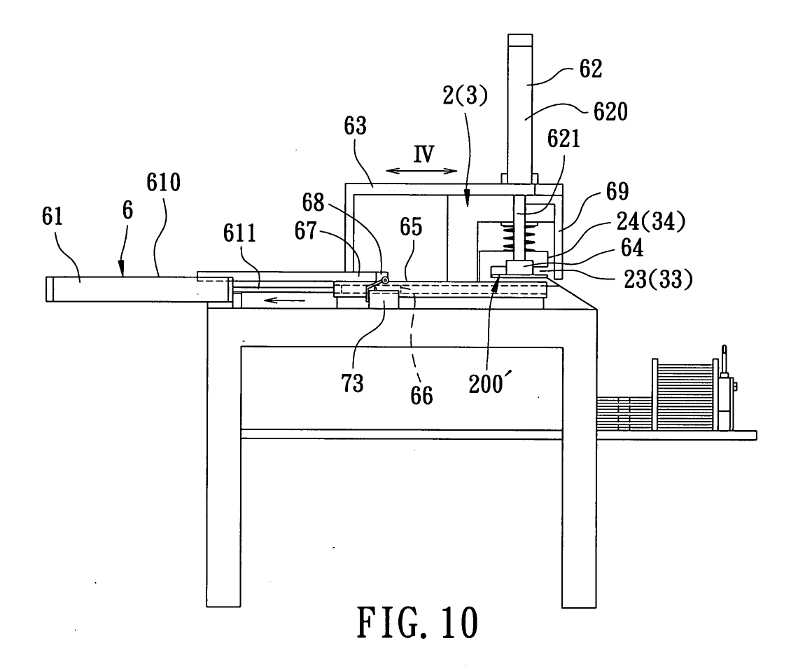

Referring to FIGS. 5 and 10, the second driving rod unit 6 includes a first fluid pressure cylinder 61, a second fluid pressure cylinder 62, a connecting frame 63, a suction nozzle 64, a second slide seat 65, a second sliding block 66, a second contact block 67, a second push block 68 and a push rod 69. The first fluid pressure cylinder 61 extends along the second direction (IV) perpendicular to the first direction (III), and includes a first cylinder body 610 disposed fixedly on the machine bed 100, and a first piston rod 611 movable relative to the first cylinder body 610. The connecting frame 63 is disposed fixedly on the second sliding block 66. The second fluid pressure cylinder 62 extends along the third direction (V), and includes a second cylinder body 620 and a second piston rod 621. The second cylinder body 620 is disposed fixedly on the connecting frame 63. The second piston rod 621 is movable relative to the second cylinder body 620. The suction nozzle 64 is attached to a lower end of the second piston rod 621. The second slide seat 65 is disposed fixedly on the machine bed 100. The second sliding block 66 is connected fixedly to the first piston rod 611, and is disposed movably within the second slide seat 65 along the second direction (IV) so as to guide the first piston rod 611 to move along the second direction (IV). The second contact block 67 is connected fixedly to the second sliding block 66. The second push block 68 is connected fixedly to the second sliding block 66. The push rod 69 is connected fixedly to the connecting frame 63, as shown in FIG. 5.

Referring to FIGS. 5, 6, 7 and 12, the driving unit 4 further includes a driving rod 41, a third fluid pressure cylinder 42, a pinion 43, a projection 44 and a plurality of cams 45. The driving rod 41 is journalled on the machine bed 100, and extends along the first direction (III). The third fluid pressure cylinder 42 has a third cylinder body 420 disposed fixedly on the machine bed 100, and a third piston rod 421 movable relative to the third cylinder body 420 and perpendicular to the driving rod 41. The third piston rod 421 is formed with an integral rack 4211. The pinion 43 is sleeved fixedly on the driving rod 41, and engages the rack 4211 of the third piston rod 421. Thus, movement of the third piston rod 421 relative to the third cylinder body 420 results in rotation of the driving rod 41. The cams 45 are connected fixedly to the driving rod 41. The cutters 25, 35 of the cutter units 2 and the punching units 3 are biased by the resilient members 26, 36 to press respectively against the cams 45. As such, when the driving rod 41 rotates, the cams 45 move the cutters 25, 35.

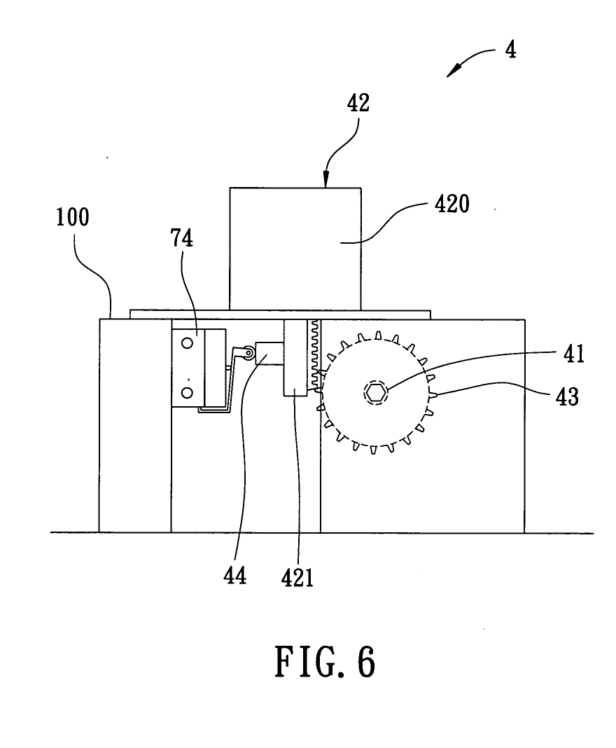

Referring to FIGS. 5, 6, 8 and 10, the switch unit 7 is connected to the control unit 1, and includes first, second, third and fourth contact switches 71, 72, 73, 74, and a photoelectric sensor 75. The first contact switch 71 corresponds to the push rod 69, as shown in FIG. 8. The second contact switch 72 corresponds to the first contact block 57, as shown in FIG. 8. The third contact switch 73 is in contact with the second contact block 67, as shown in FIG. 10. The fourth contact switch 74 is in contact with the projection 44 of the driving unit 4, as shown in FIG. 6. The photoelectric sensor 75 is disposed on the middle punching unit 3.

Referring to FIGS. 5 and 8, the collecting unit 8 includes a semi-product collecting box 81 and a product-collecting box 82. The product-collecting box 82 is disposed below and in proximity to the cutting units 2 and the punching units 3. The semi-product collecting box 81 is disposed in proximity to the product-collecting box 82. The product-collecting box 82 is disposed between the semi-product collecting box 81 and an assembly of the cutting units 2 and the punching units 3.

Referring to FIG. 12, the lower anvil wall 241, 341 of the anvil 24, 34 of each of the cutting units 2 and the punching units 3 has an inclined end surface 2411, 3411 connected to and aligned with an inclined surface 211, 311 of corresponding base 21, 31. The inclined end surfaces 2411, 3411 and the inclined surfaces 211, 311 are disposed between the product-collecting box 82 and the openings 23, 33 in the anvils 24, 34 of the cutting units 2 and the punching units 3.

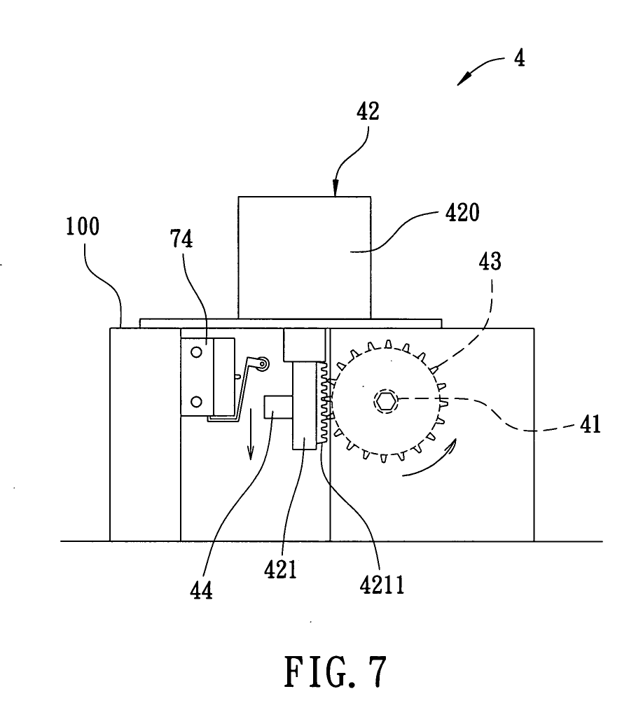

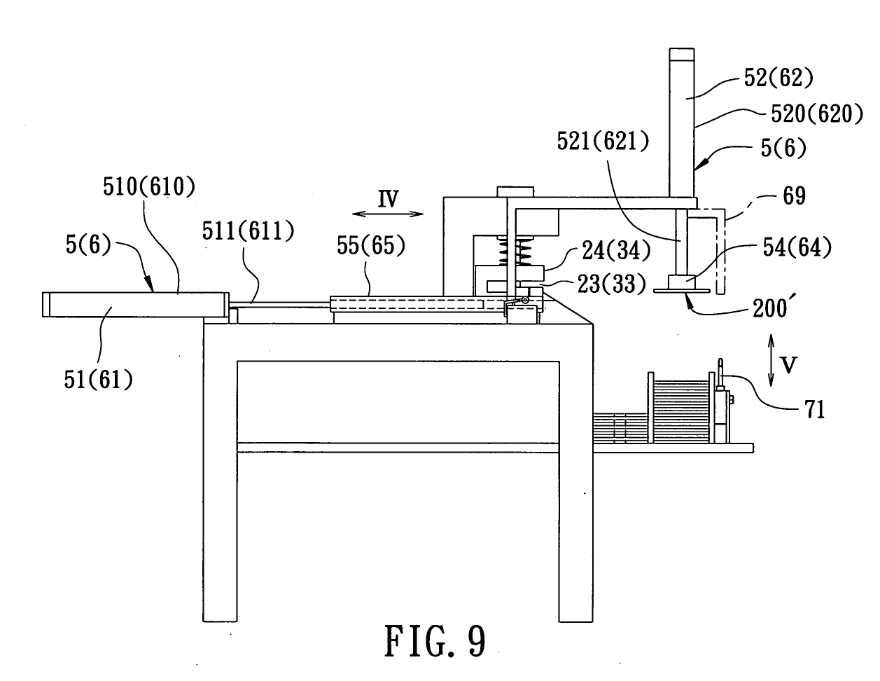

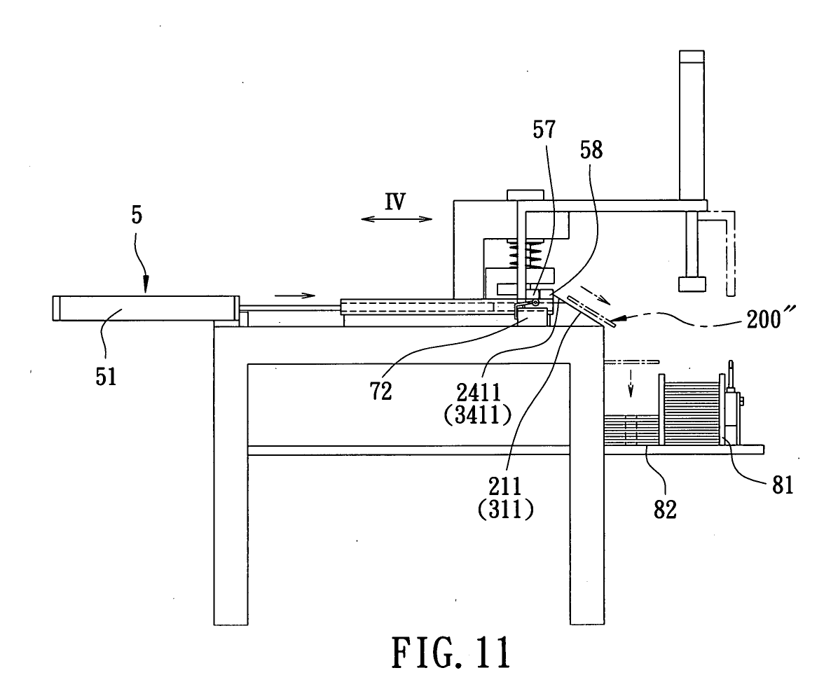

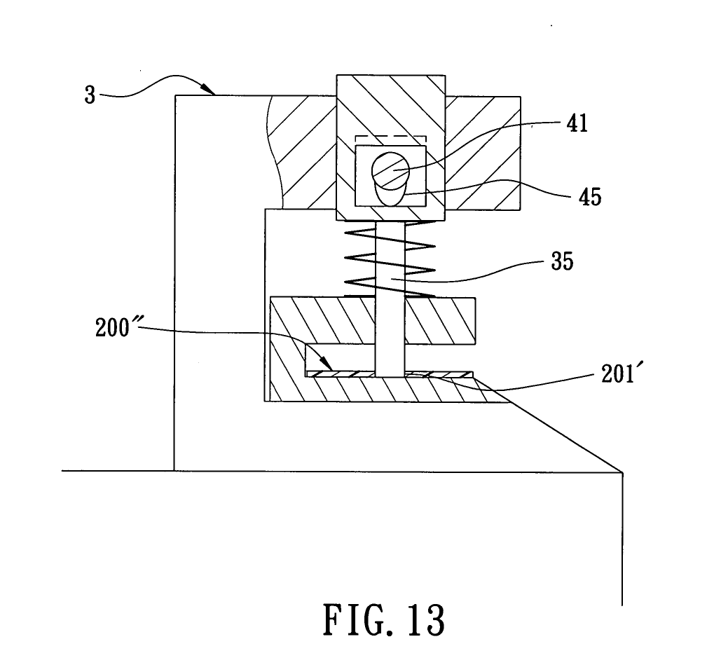

Referring to FIGS. 5, 6, 8, 9 and 12, under automatic control of the control unit 1, when the automatic control pushbutton 102 is pressed, the slat-forming machine performs the following operations:
(1) The first piston rods 511, 611 of the first and second driving rod units 51, 61 move to the right along the second direction (IV). When the second fluid pressure cylinders 52, 62 move to positions directly above the semi-product collecting box 81, the first piston rods 511, 611 stop.
(2) The second piston rods 521, 621 move downwardly along the third direction (V). When the push rod 69 moves with the second piston rod 621 of the second driving unit 6 to contact the first contact switch 71, the second piston rods 521, 621 stop.
(3) The uppermost plate 200′ are sucked onto the suction nozzles 54, 64.
(4) The second piston rods 521, 621 move upwardly to the positions shown in FIG. 9.
(5) The first piston rods 511, 611 move to the left so as to move the plate 200′ into the openings 23, 33 in the anvils 24, 34 of the cutting units 2 and the punching units 3. At this time, the plate 200′ blocks a light beam emitted from the photoelectric sensor 75, and the second contact block 67 separates from the third contact switch 73. Hence, the first piston rods 511, 611 stop, and the suction nozzles 54, 64 releases the plate 200′ therefrom.
(6) The third piston rod 421 moves downwardly to a lower limit position shown in FIG. 7 so as to rotate the driving rod 41. Hence, the cams 45 move the cutters 25, 35 of the cutting units 2 and the punching units 3 to perform cutting and punching operations on the plate 200′. When the third piston rod 421 is disposed at the lower limit position, the cutters 25, 35 are also at their lower limit positions, as shown in FIG. 13 such that the cutting and punching operations are finished. Therefore, a window blind slat 200″ is formed with three slots (201′) (see FIG. 13) and two curved end edges (not shown). When the third piston rod 421 moves downwardly from the position shown in FIG. 6, the projection 44 separates from the fourth contact switch 74. The fourth contact switch 74 senses the separation of the projection 44, and therefore transmits a signal to the control unit 1. As a result, the control unit 1 performs control such that after the third piston rod 421 reaches the lower limit position, it is returned to the position shown in FIG. 6 under the automatic control. When the third piston rod 421 is disposed at the position shown in FIG. 6, the projection 44 contacts the fourth contact switch 74 once again.
(7) The recontact between the projection 44 and the fourth contact switch 74 results in rightward movement of the first piston rods 511, 611 to the position shown in FIG. 11. When the first contact block 57 contacts the second contact switch 72, the rightward movement of the first piston rods 511, 611 stops. As such, the window blind slat 200″ is pushed by the push blocks 58, 68 to drop and slide from the openings 23, 33 in the anvils 24, 34 of the cutting units 2 and the punching units 3 into the product-collecting box 82 along the inclined surfaces 211, 311 and the inclined end surfaces 2411, 3411 of the cutting units 2 and the punching units 3.

As such, the slat-forming machine of this invention is a fully automatic machine, and therefore has the following advantages:
(1) Because feeding of the plate 200′ and removal of the window blind slat 200″ are performed under automatic control of the control unit 1, the window blind slot 200″ can be mass-produced effectively.
(2) The plate 200′ is fed mechanically into the openings 23, 33 in the anvils 24, 34 of the cutting units 21 and the punching units 3. Thus, the slots 201′ and the curved end edges can be formed accurately at selected positions of the plate 200′.

With this invention thus explained, it is apparent that numerous modifications and variations can be made without departing from the scope and spirit of this invention. It is therefore intended that this invention be limited only as indicated by the appended claims.

I claim:

1. An automatic slat-forming machine for cutting and punching a plate to form a window blind slat, said automatic slat-forming machine comprising:
a machine bed;
a control unit;
a plurality of cutting units disposed on said machine bed and arranged along a first direction;
a plurality of punching units disposed on said machine bed and arranged along said first direction;
a driving unit disposed on said machine bed and connected to said cutting units and said punching units; and
a pair of first and second driving rod units, each of which includes
a first fluid pressure cylinder extending along a second direction perpendicular to said first direction and including a first cylinder body disposed fixedly on said machine bed, and a first piston rod movable relative to said first cylinder body,
a connecting frame disposed fixedly on said first piston rod,
a second fluid pressure cylinder extending along a third direction perpendicular to said first and second directions and including a second cylinder body disposed fixedly on said connecting frame, and a second piston rod movable relative to said second cylinder body, and
a suction nozzle attached to an end of said second piston rod;
said control unit being operable to move said second piston rods along said third direction to predetermined positions, where the plate is sucked onto said suction nozzles, after which said first and second piston rods move to feed the plate into said cutting units and said punching units, said suction nozzles releasing the plate therefrom in response to movement of the plate into said cutting units and said punching units, said driving unit driving said cutting units and said punching units to perform cutting and punching operations on the plate under automatic control of said control unit when the plate is released from said suction nozzles.

2. The automatic slat-forming machine as claimed in claim 1, wherein said driving unit includes:
a third fluid pressure cylinder having a third cylinder body disposed fixedly on said machine bed, and a third piston rod movable relative to said third cylinder body; and
a driving rod journalled on said machine bed and perpendicular to said third piston rod, said driving rod extending along said first direction and being connected to all of said third piston rod, said cutting units and said punching units such that movement of said third piston rod relative to said third cylinder body results in rotation of said driving rod, thereby driving said cutting units and said punching units to perform the cutting and punching operations.

3. The automatic slat-forming machine as claimed in claim 2, further comprising:
a product-collecting box disposed below and in proximity to said cutting units and said punching units for receiving the window blind slat dropping from said cutting units and said punching unit; and
a semi-product collecting box disposed in proximity to said product-collecting box such that said product-collecting box is disposed between said semi-product collecting box and an assembly of said cutting units and said punching units.

4. The automatic slat-forming machine as claimed in claim 1, further comprising a switch unit connected to said control unit;
said first driving rod unit further including:
a first slide seat disposed fixedly on said machine bed,
a first sliding block connected fixedly to said first piston rod of said first driving rod unit and disposed movably within said first slide seat along said second direction so as to guide said first piston rod of said first driving rod unit to move along said second direction, and
a first contact block connected fixedly to said first sliding block of said first driving rod unit;
said third piston rod of said third fluid pressure cylinder being formed with a fixed projection;
said second driving rod unit further including:
a second slide seat disposed fixedly on said machine bed,
a second sliding block connected fixedly to said first piston rod of said second driving rod unit and disposed movably within said second slide seat along said second direction so as to guide said first piston rod of said second driving rod unit to move along said second direction,
a second contact block connected fixedly to said second sliding block of said second driving rod unit, and
a push rod connected fixedly to said connecting frame of said second driving rod unit and extending along said third direction;
said switch unit including:
a first contact switch corresponding to said push rod, said push rod being movable with said second piston rod of said second driving rod unit along said third direction to contact said first contact switch so as to stop movement of said second piston rods and so as to allow the plate to be sucked onto said suction nozzle,
a second contact switch corresponding to said first contact block, said first contact block being movable with said first piston rod of said first driving rod unit along said second direction to contact said second contact switch so as to stop movement of said first piston rods,
a third contact switch in contact with said second contact block, said second contact block being movable with said second piston rod of said second driving rod unit to separate from said third contact switch,
a photoelectric sensor cooperating with said third contact switch to release the plate from said suction nozzle and to drive said driving unit so that said cutting units and said punching units cooperate to perform said cutting and punching operations on the plate in response to movement of the plate into said cutting units and said punching units, thereby forming the window blind slat, and
a fourth contact switch disposed in proximity to said driving unit, said projection of said third piston rod of said third fluid pressure cylinder coming into contact with said fourth contact switch when said cutting and operating operations are finished, contact between said projection and said fourth contact switch resulting in movement of said first piston rods of said first and second driving rod units along said second direction so as to push the window blind slat into said product-collecting box.

5. The automatic slat-forming machine as claimed in claim 4, wherein said first driving rod unit further includes a first push block connected fixedly to said first sliding block, and said second driving rod unit further includes a second push block connected fixedly to said second sliding block.

6. The automatic slat-forming machine as claimed in claim 1, wherein each of said cutting units and said punching units includes:
a base;
a cutter seat disposed above said base;
an anvil disposed between said base and said cutter seat and having an opening and a lower anvil wall that defines a lower end of said opening and that is formed with an inclined end surface, said inclined end surface being disposed between said opening and said product-collecting box such that the plate can slide from said opening into said product-collecting box along said inclined end surface; and
a cutter movable vertically relative to said cutter seat and connected to said driving rod.
